(19) United States
(12) Patent Application Publication
(10) Pub. No.: US 2012/0024475 A1
(43) Pub. Date: Feb. 2, 2012

(54) DISPLAY BONDING DEVICE AND METHOD

(75) Inventors: Masayuki KITAJIMA, Kawasaki (JP); Hidehiko KOBAYASHI, Kawasaki (JP)

(73) Assignee: FUJITSU LIMITED, Kawasaki-shi (JP)

(21) Appl. No.: 13/186,798

(22) Filed: Jul. 20, 2011

(30) Foreign Application Priority Data
Jul. 30, 2010 (JP) 2010-171272

(51) Int. Cl. B32B 37/10; B32B 37/14; B32B 37/02

(52) U.S. Cl. 156/312; 156/580

(57) ABSTRACT

A display bonding device includes a stage configured to place an adhesive tape and an adherend thereon, a pressure head configured to press the adhesive tape onto the adherend with a pressure surface having a tapered shape or a curved shape which is tilted with respect to the stage, and a movement mechanism configured to move the pressure head toward the adhesive tape through a pressure rod which is coupled to the pressure head. The pressure head is configured to rotate around the pressure rod.

### CROSS-REFERENCE TO RELATED APPLICATION

This application is based upon and claims the benefit of priority of Japanese Patent Application No. 2010-171272, filed on Jul. 30, 2010, the entire contents of which are incorporated herein by reference.

### FIELD

The embodiments discussed herein relate to a display bonding device and a display bonding method.

### BACKGROUND

Conventionally, a pressure sensitive adhesive double coated tape is used for bonding a display to an electronic device, such as a mobile phone. When attaching the adhesive tape to a display, which is an adherend (workpiece), a method configured to press the adhesive tape by a roller is used in order to apply a uniform load to the adhesive tape to achieve a secure contact between the adhesive tape and an attaching surface of the adherend and expel air bubbles that easily enter between the adhesive tape and the adherend.

On the other hand, a pressure head method can be used instead of the method using a roller in order to speed up the attaching operation in mass production of electronic devices, and further, in order to realize an operation to attach the adhesive tape to a display with a high degree of accuracy, or because it is difficult to attach an adhesive tape to an attaching surface of an adherend which has concaves and convexes. The pressure head method is a method for applying pressure by pressing a pressure head having a shape corresponding to the shape of the attaching surface of the adherend to the attaching surface between the adhesive tape and the adherend.

As illustrated in FIG. 10, when attaching a glass plate 102 to a housing 100 of a mobile phone or the like with a pressure sensitive adhesive double coated tape 104, an attaching surface of the adhesive tape 104 is pressed to an attaching surface of the housing 100, and the adhesive tape 104 is pressed by a pressure head, so that the adhesive tape is attached to the housing 100. Protective paper is peeled from the surface of the adhesive tape 104 and the glass plate 102 is pressed and attached to the adhesive tape 104 attached to the housing 100 with the pressure head.

The pressure head method and the method for applying pressure with a roller are disclosed, for example, in Japanese Unexamined Patent Application Publication No. 06-48640 or Japanese Unexamined Patent Application Publication No. 2004-42270.

However, in a conventional attaching method using a pressure head, as illustrated in FIGS. 11A to 11D, adhesive failure 106 and residual air bubbles 108 occur in the adhesive tape, so the bonding strength of the adhesive tape may be decreased. In particular, when attaching an adhesive tape to a display such as a large scale liquid crystal display panel, the adhesive failure 106 and the residual air bubbles 108 easily occur. In conventional methods, the rate of attaching failure due to the adhesive failure 106 or the residual air bubbles 108 is about 0.2%.

The adhesive failure 106 here means, for example, that the adhesive tape does not come in contact with the adherend as illustrated in FIGS. 11A and 11B and a certain range of area is formed where the adhesive tape is not sufficiently pressed to the adherend and the adhesive tape does not adhere to the adherend. The residual air bubbles 108 means, for example, a plurality of air bubbles that are enclosed between the adhesive tape and the adherend as illustrated in FIGS. 11C and 11D.

On the other hand, in the method for applying pressure with a roller, if there are concaves and convexes on the attaching surface of the adherend, the adhesive failure 106 or the residual air bubbles 108 easily occur, so the method is effective only when the adhesive tape is attached to a flat and smooth surface. Further, the method using a roller takes a long operation time in mass production, and it is difficult for a small-sized display to be attached.

### SUMMARY

According to an embodiment of the invention, a display bonding device includes a stage configured to place an adhesive tape and an adherend thereon, a pressure head configured to press the adhesive tape onto the adherend with a pressure surface having a tapered shape or a curved shape which is tilted with respect to the stage, and a movement mechanism configured to move the pressure head toward the adhesive tape through a pressure rod which is coupled to the pressure head. The pressure head is configured to rotate around the pressure rod.

The object and advantages of embodiments of the invention will be realized and achieved by means of the elements and combinations particularly pointed out in the claims. It is to be understood that both the foregoing general description and the following detailed description are exemplary and explanatory, and are not restrictive of the invention.

### BRIEF DESCRIPTION OF DRAWINGS

FIG. 1A is a front view showing a schematic configuration of a display bonding device of an embodiment;

FIG. 1B is a side view of the display bonding device.

FIG. 2 is a schematic view of a pressure head used in an embodiment.

FIGS. 3A to 3C are views for explaining variation of tilt angle of a pressure surface of the pressure head used in an embodiment.

FIGS. 4A and 4B are views for explaining a first modified example of an embodiment.

FIGS. 5A and 5B are views for specifically explaining an operation of the first modified example.

FIG. 6 is a view for explaining a second modified example of an embodiment.

FIGS. 7A and 7B are views for explaining a third modified example of an embodiment.

FIGS. 8A and 8B are views for explaining a fourth modified example of an embodiment.

FIG. 9 is a view for explaining a specific example of the fourth modified example.

FIG. 10 is a view for explaining an example of attaching a glass plate to a housing of an electronic device.

FIGS. 11A to 11D are views for explaining a problem occurring in a conventional bonding method.

### DESCRIPTION OF EMBODIMENTS

Hereinafter, a display bonding device and a display bonding method according to embodiments of the present invention will be described.

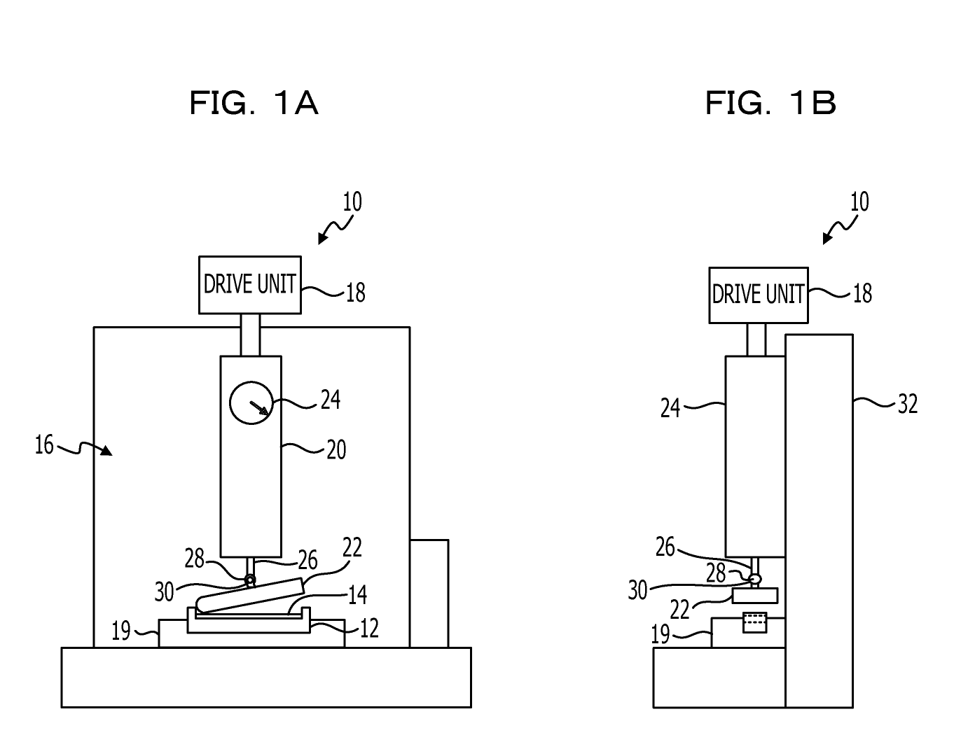

FIG. 1A is a front view showing a schematic configuration of a display bonding device 10 of an embodiment of the present invention. FIG. 1B is a side view of the display bonding device 10, according to an embodiment.

When bonding a display glass plate to, for example, a resin housing 12 of a mobile phone, which is an adherend, the display bonding device 10 performs an attaching operation using a pressure sensitive adhesive double coated tape (herein after referred to as “adhesive tape”) 14.

The display bonding device 10 may have a device main body 16 and a drive unit 18.

The device main body 16 may have a stage 19, a pressure head movement mechanism 20, and a pressure head 22.

In one embodiment, the pressure head movement mechanism 20 is provided with a pressure gauge 24, a pressure rod 26, and a pressure rod connection unit 28. The pressure head 22 can be provided with a pressure head connection unit 30.

According to an embodiment, the stage 19 is attached to a base 32, and has a mounting surface on which the housing 12 with an adhesive tape 14 thereon is mounted.

The pressure head movement mechanism 20 is attached to the base 32. The pressure head movement mechanism 20 moves the pressure rod 26 toward the housing 12 and the adhesive tape 14 through a drive shaft extended from the drive unit 18. The pressure head 22 may be connected to the bottom end of the pressure rod 26, so the pressure head 22 may be pressed from above the adhesive tape 14 by lowering the pressure rod 26.

The pressure gauge 24, in one example, is a sensor configured to measure pressure information of the pressure head 22. For example, the pressure gauge 24 is provided with a load cell and measures the pressure information. The measurement result is transferred to the drive unit 18 and used for feedback control of pressure of the pressure head 22. A strain gauge may be used to measure the strain of the pressure rod 22 instead of the load cell. Or, the pressure rod 22 may be provided with a pressure spring instead of the load cell, and a reduction of the length of the pressure spring may be measured.

The drive unit 18 is a driving source configured to move the pressure rod 26 and includes, for example, a drive motor.

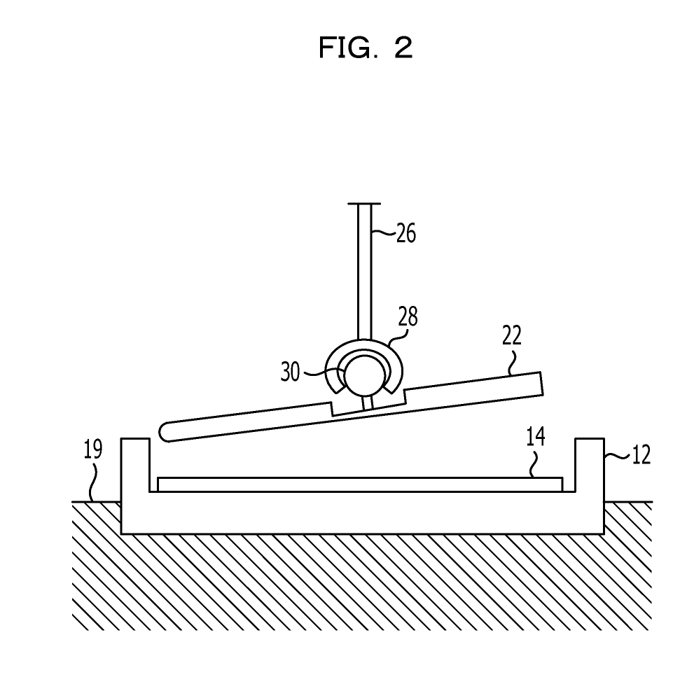

FIG. 2 is a view for specifically explaining the pressure head 22 and the periphery thereof.

The pressure head 22 is a member configured to press the housing 12 and the adhesive tape 14 with a pressure surface which is a tapered surface tilted in one direction with respect to the mounting surface of the stage 19. The pressure head 22 is a metal member formed, for example, of SUS, SPCC (JIS G3141), or the like. The pressure rod 26 goes down to or up from the housing 12 and the adhesive tape 14. The movements of going down and up may be fixed to one direction.

In one embodiment, a spherically concave portion facing the pressure rod 26 can be provided to the pressure rod connection unit 28 where the pressure rod 26 connects with the pressure head 22.

On the other hand, in an embodiment, a spherical convex portion swingably connected with the concave portion of the pressure rod connection unit 28 can be provided to the pressure head connection portion 30 where the pressure head 22 connects with the pressure rod 26. Thereby, the pressure head 22 may rotate around the pressure rod 26. In other words, the pressure head 22 and the pressure rod 26 can be connected to each other via a ball joint.

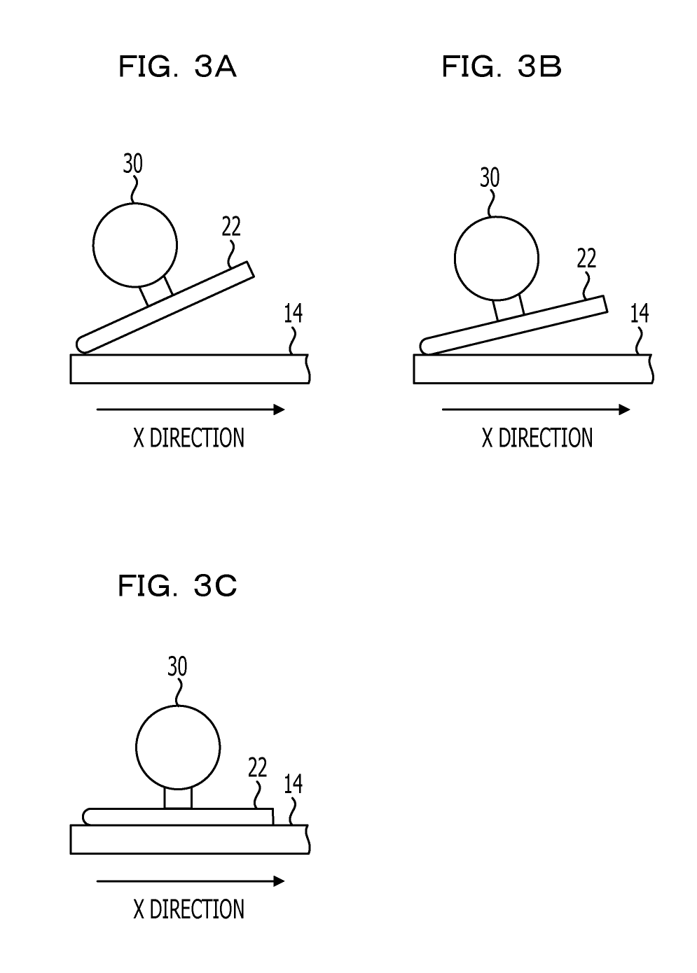

The pressure surface of the pressure head 22 is a tapered surface tilted in one direction and the pressure head 22 may rotate around the pressure rod 26. Therefore, as illustrated in FIG. 3A to 3C, the tilt angle of the pressure surface decreases when the pressure head 22 goes down and starts to be in contact with the adhesive tape 14 and the tilt angle becomes 0 (becomes horizontal) with respect to the mounting surface of the stage 19 when the pressure surface comes in complete surface contact with the adhesive tape 14.

In this way, the pressure surface of the pressure head 22 starts to be in contact with the adhesive tape 14 from the left end in FIGS. 3A to 3C, so air bubbles between the adhesive tape 14 and the housing 12 are pressed in the X direction in FIGS. 3A to 3C, and finally, in a state shown in FIG. 3C, the air bubbles are pressed out from the right end of the pressure surface of the pressure head 22.

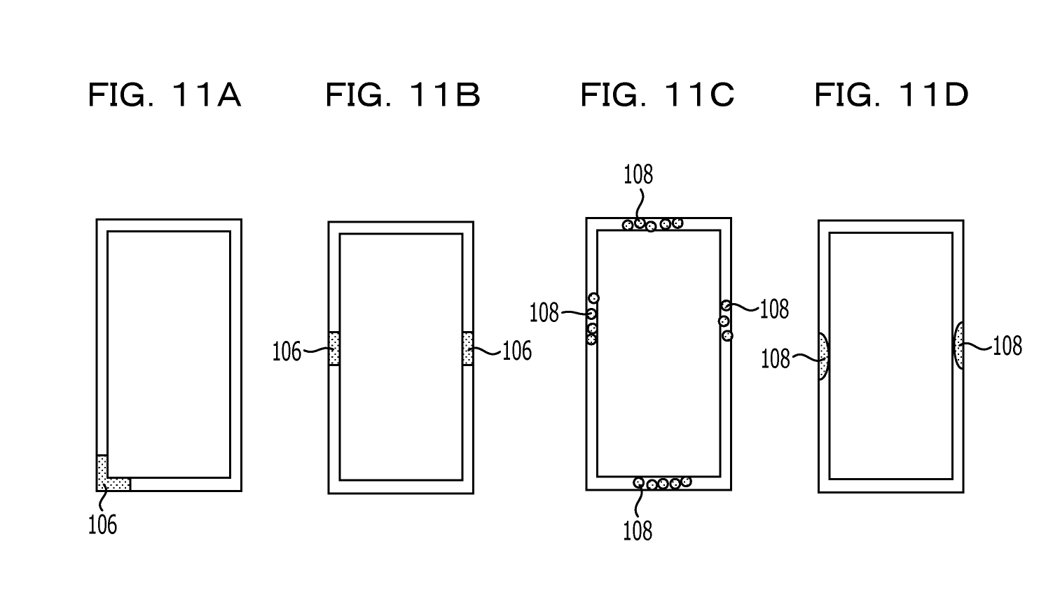

Further, regarding the tilt angle of the pressure surface of the pressure head 22, since the pressure head 22 may rotate around the pressure rod 26, even if there are minute concaves and convexes of the housing 12 along the X direction or there are minute concaves and convexes along a direction perpendicular to the X direction (a direction perpendicular to the page surface of FIGS. 3A to 3C), the pressure surface may be rotated following the concaves and convexes. Therefore, a partial contact (see FIGS. 11A and 11B), which occurs in conventional techniques, is unlikely to occur. The rate of occurrence of attaching failure due to a partial contact 106 or residual air bubbles 108 is, for example, about 0.02%.

As illustrated in FIGS. 2 and 3A to 3C, the left end portion of the pressure head 22 which first comes in contact with the adhesive tape 14 is rounded to a semicircular shape. One reason for this is to prevent the portion of the pressure head 22 which first comes in contact with the adhesive tape 14 from damaging the adhesive tape 14.

Although, in this embodiment, a spherical concave portion is provided to the pressure rod connection unit 28 and a spherical convex portion is provided to the pressure head connection unit 30, a spherical convex portion may be provided to the pressure rod connection unit 28 and a spherical concave portion may be provided to the pressure head connection unit 30.

Although, in this embodiment, the pressure head connection unit 30 is connected to the pressure rod connection unit 28 by a combination of convex and concave portions so that the pressure head 22 may rotate around the pressure rod 26, the connection form between the pressure rod connection unit 28 and the pressure head connection unit 30 is not limited to the connection formed by the combination of convex and concave portions.

It is preferable, according to one embodiment, that an anti-slip resin sheet having a thickness of 10 mm or less is provided on the pressure head 22. The resin sheet may prevent the surface of the pressure head 22 from slipping on the adhesive tape 14, so it is possible to more effectively suppress occurrence of partial contact and reduce residual air bubbles. It is preferable that the resin sheet is, for example, a natural rubber sheet, a urethane rubber sheet, or a silicone rubber sheet.

### First Modified Example

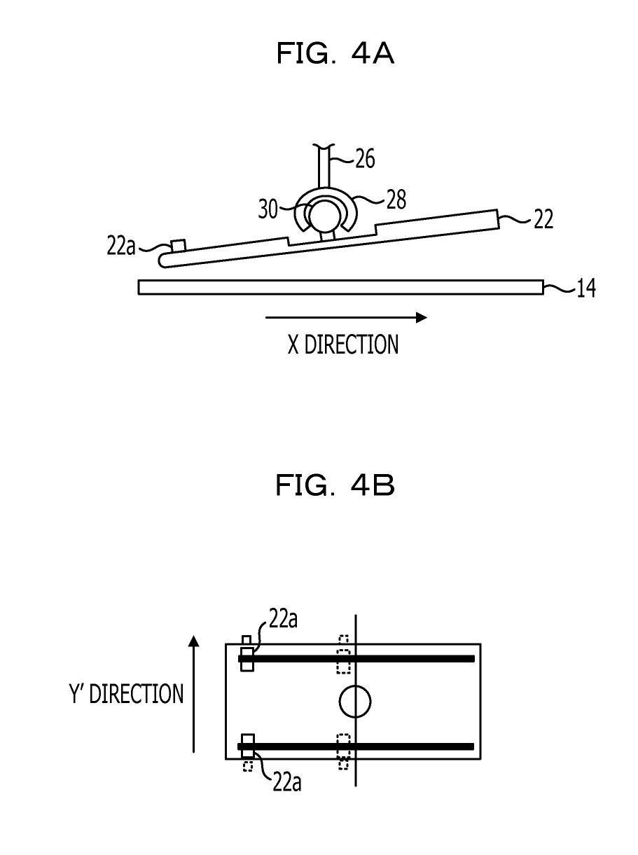

FIGS. 4A and 4B are views for explaining a first modified example of the pressure head 22 of the above-described embodiment.

The pressure head 22 of the first modified example may be different from the pressure head 22 illustrated in FIG. 2, and includes a pair of balancers 22a that may move on the pressure head 22. Grooves extending in the X direction are provided on a surface opposite to the pressure surface of the pressure head 22, and the balancers 22a may slide on the grooves. The display bonding device 10 used in the first modified example is similar to that of the above-described embodiment except for the pressure head 22.

According to one embodiment, a pair of balancers 22a is provided in the Y direction. By providing the balancers 22a, it is possible to adjust the tilt angle of the pressure surface of the pressure head 22 with respect to the mounting surface of the stage 19 to a predetermined value. The tilt angle of the pressure surface is adjusted according to usage conditions such as the thickness of the adhesive tape 14 to be used and the hardness of the housing 12. The reason for adjusting the tilt angle according to usage conditions is because the tilt angles at which the partial contact 106 or residual air bubbles 108 are unlikely to occur are different depending, for example, on the thickness of the adhesive tape 14 to be used, the hardness of the housing 12, and the like.

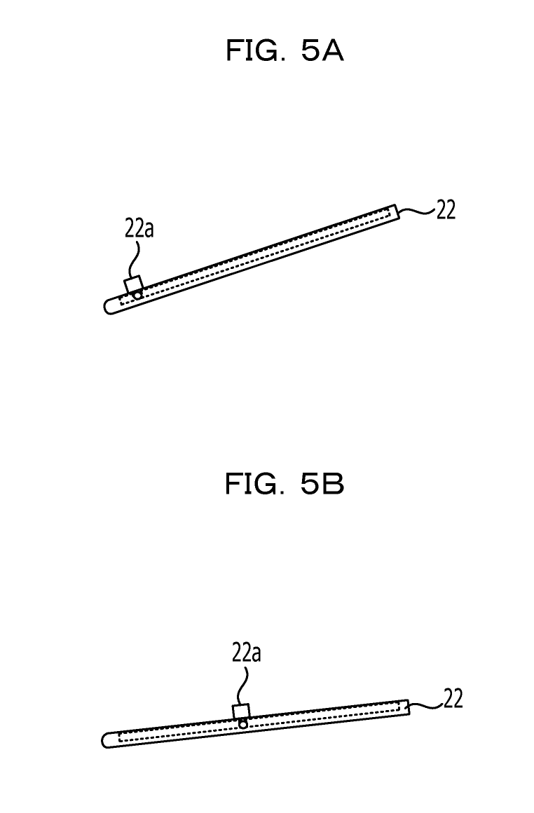

As illustrated in FIG. 5A, by placing the balancer 22a at the left end, it is possible to increase the tilt angle, for example, to about 10 to 15 degrees. By moving the balancer 22a to the center, it is possible to decrease the tilt angle, for example, to about 5 degrees.

Although, in the first modified example, a pair of balancers 22a are provided in the Y direction, the number of balancers 22a may be one or three or more. Although the balancer 22a slides on a groove, the moving method and the placing method of the balancer 22a are not particularly limited.

### Second Modified Example

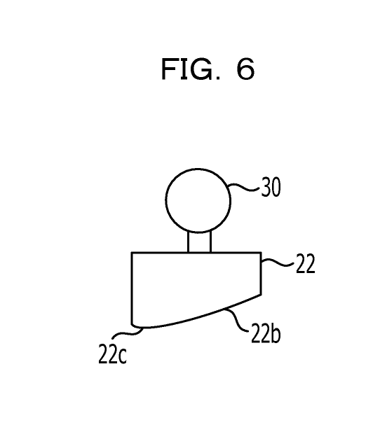

FIG. 6 is a view for explaining a second modified example of the pressure head 22 of the above-described embodiment. The display bonding device 10 used in the second modified example may be the same as that of the above-described embodiment except for the pressure head 22.

Although the pressure head 22 of the embodiment has a tapered surface as a tilted pressure surface which is formed by a flat plate tilted in one direction, as illustrated in FIG. 6, the pressure head 22 of the second modified example has a curved surface 22b where the pressure surface is tilted in one direction. Further, the pressure head 22 may rotate around the pressure rod 26 and further with respect to the pressure rod 26. Therefore, when the pressure head 22 moves down so as to be in contact with the adhesive tape 14, the pressed position on the adhesive tape 14 moves in the X direction as the pressure head 22 moves down. Therefore, as illustrated in FIGS. 3A to 3C, the air bubbles are pressed out in the X direction. Further, since the pressure head 22 may rotate around the pressure rod 26, even if there are minute concaves and convexes of the housing 12 along the X direction or there are minute concaves and convexes along a direction perpendicular to the X direction, the pressure surface may be rotated following the concaves and convexes. Therefore, a partial contact (see FIGS. 11A and 11B) which occurs in conventional techniques is unlikely to occur.

The curved surface 22b may also be curved in a cross section in a direction perpendicular to the page surface of the example of FIG. 6. In this case, if there are minute concaves and convexes of the housing 12 in a direction perpendicular to the X direction, the pressure surface may more uniformly press the adhesive tape 14 following the concaves and convexes.

The left edge 22c of the pressure surface in FIG. 6 is chamfered with a curvature. One reason for this is to prevent the edge portion of the pressure head 22 from damaging the adhesive tape 14 when the edge portion first comes in contact with the adhesive tape 14.

### Third Modified Example

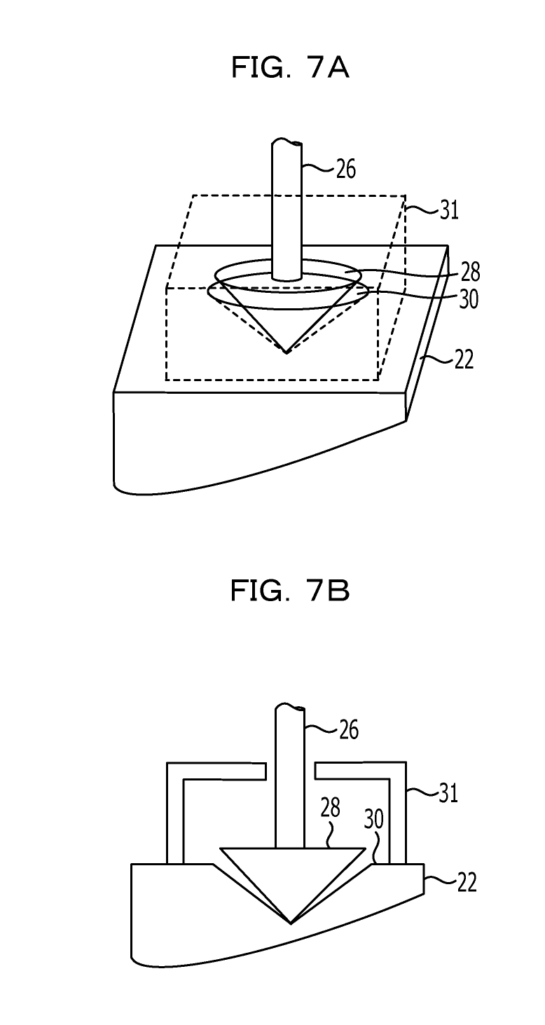

FIGS. 7A and 7B are views for explaining a modified example of the pressure head 22 and the pressure rod 26 of the above-described embodiment. The display bonding device 10 used in the third modified example may be the same as that of the above-described embodiment except for the portions described below of the pressure head and the pressure rod in the third modified example.

The pressure rod connection unit 28 of the pressure rod 26 and the pressure head connection unit 30 of the pressure head 22 of the third modified example may be different from the pressure head 22 and the pressure rod 26 illustrated in FIG. 2, and a conical convex portion and a conical concave portion are formed.

Specifically, in one example, a conical convex portion facing the pressure head 22 is provided to the pressure rod connection unit 28 where the pressure rod 26 connects with the pressure head 22. On the other hand, according to one embodiment, a conical concave portion which is swingably connected with the convex portion of the pressure rod 26 when the pressure head 22 presses the adhesive tape 14 can be provided to the pressure head connection portion 30 where the pressure head 22 connects with the pressure rod 26. Thereby, the pressure head 22 may rotate around the pressure rod 26. Although, in the example illustrated in FIG. 7, the pressure head 22 is the pressure head of the second modified example illustrated in FIG. 6, the pressure head 22 may be one of the pressure heads 22 shown in FIGS. 2, 4A to 4C, and 5A and 5B.

In the third modified example, a connection holding body 31 is provided which is extended from the pressure head 22 and covers the pressure rod connection unit 28 and the pressure head connection unit 30. The pressure rod 26 enters the internal space of the connection holding body 31 through an opening which is formed in the connection holding body 31 and has a diameter smaller than the maximum diameter of the conical shape of the pressure rod connection unit 28. The diameter of the pressure rod 26 is smaller than the diameter of the opening of the connection holding body 31. As a result, the pressure rod 26 passes through the opening of the connection holding body 31 so that play remains, and the pressure rod connection unit 28 cannot be pulled out from the connection holding body 31. When the pressure rod 26 moves down and starts to press the pressure head 22, the pressure rod 26 comes in contact with the conical concave portion of the pressure head 22 and applies pressure to the pressure head 22.

At this time, the opening angle of the conical concave portion of the pressure head connection unit 30 may be larger than the opening angle of the conical convex portion of the pressure rod connection unit 28, so the pressure head 22 may easily move in a certain range.

Therefore, the third modified example exerts the same effect as that of the above-described embodiment, the first modified example, and the second modified example by performing the same operation.

Although, in the third modified example, a conical convex portion is provided to the pressure rod connection unit 28 and a conical concave portion is provided to the pressure head connection unit 30, a conical concave portion may be provided to the pressure rod connection unit 28 and a conical convex portion may be provided to the pressure head connection unit 30. A circular truncated conical shape may be used instead of the conical shape. In these cases, the opening angle of the conical convex portion or the circular truncated conical convex portion of the pressure rod connection unit 28 is larger than the opening angle of the conical concave portion or the circular truncated conical concave portion of the pressure head connection unit 30.

### Fourth Modified Example

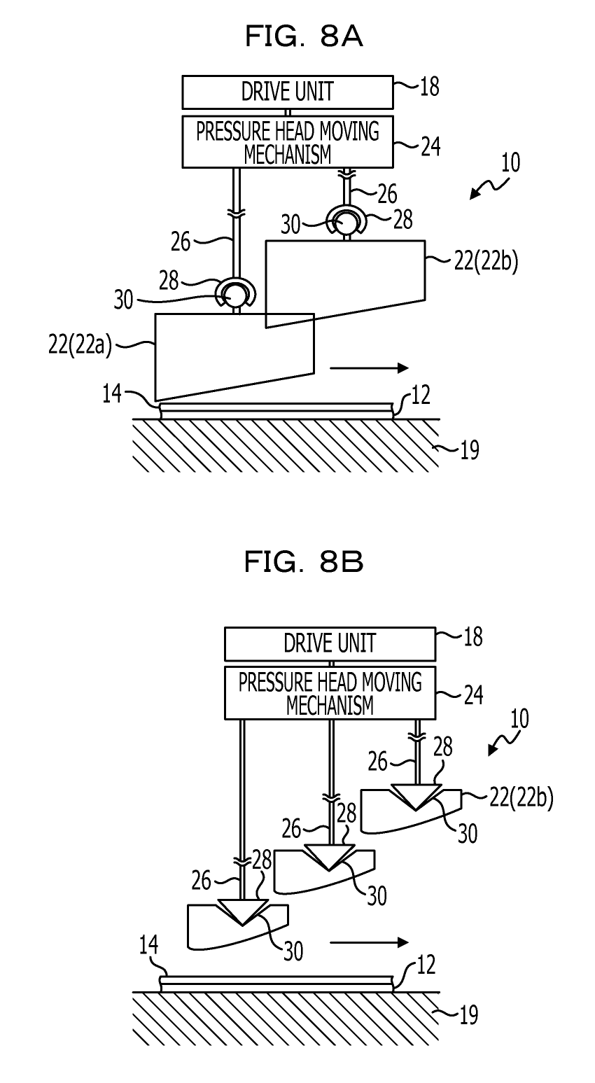

FIGS. 8A and 8B are views for explaining a schematic configuration of a pressure head 22 of a fourth modified example. In the fourth modified example, a plurality of pressure heads 22 can be provided to the display bonding device 10.

Regarding the pressure head 22 illustrated in FIG. 8A, the pressure rod connection unit 28 has a spherical concave portion and the pressure head connection unit 30 has a spherical convex portion as illustrated in FIG. 2. Regarding the pressure head 22 illustrated in FIG. 8B, the pressure rod connection unit 28 has a conical convex portion and the pressure head connection unit 30 has a conical concave portion as illustrated in FIGS. 7A and 7B. Therefore, each pressure head 22 may rotate around the pressure rod 26. Although the fourth modified example illustrated in FIG. 8B also has the connection holding body 31 as illustrated in FIGS. 7A and 7B, the connection holding body 31 is not illustrated in FIG. 8B.

The concave portion of the pressure head 22 may have a conical concave shape having an opening angle larger than that of the convex portion of the pressure rod 26. The shapes of the concave portion and the convex portion may be a circular truncated conical shape instead of a conical shape.

In the fourth modified example, each pressure head 22 may be provided with balancers that may move on the pressure head 22 as illustrated in FIGS. 4A and 4B, and the tilt angle of the pressure surface of the pressure head 22 may be adjusted by the position of the balancers.

A resin sheet may be provided on the pressure surface of each pressure head 22.

In the fourth modified example, the display bonding device 10 may also have the drive unit 18, the stage 19, a plurality of pressure heads 22, and the pressure head movement mechanism 20.

The drive unit 18 can be a driving source configured to move the pressure rod 26 of the pressure head movement mechanism 20 and includes, for example, a drive motor.

The housing 12 on which the adhesive tape 14 is placed may be mounted on the mounting surface of the stage 19.

In an embodiment, the pressure head movement mechanism 20 moves the pressure heads 22 downward to the housing 12 and the adhesive tape 14 through the pressure rods 26 connected to each pressure head 22 so that the pressure heads 22 presses the housing 12 and the adhesive tape 14.

The plurality of pressure heads 22 presses the adhesive tape 14 and the housing 12 with the tapered surface that is tilted in one direction with respect to the mounting surface of the stage 19 on which the adhesive tape 14 and the housing 12 are mounted or the curved surface that is tilted in at least one direction as the pressure surface.

The plurality of pressure heads 22 may be arranged in a row so that a position at which the adhesive tape 14 and the housing 12 are pressed moves sequentially in one direction.

The operation in which the plurality of pressure heads 22 attach the adhesive tape 14 to the housing 12 is performed in the flow described below.

First, a first pressure head 22a presses a first area of the adhesive tape 14. Next, a second pressure head 22b presses a second area that partially overlaps the first area. In this way, an area is pressed so that a part of the pressed area overlaps the next area to be pressed. Therefore, air bubbles between the housing 12 and the adhesive tape 14 are gradually pushed and moved in one direction. Finally, the air bubbles between the housing 12 and the adhesive tape 14 are pushed out to the outside. Further, since the direction of the move of the pressed area corresponds to the tilt direction of the pressure surface of the pressure head, it is possible to efficiently push out the air bubbles between the housing 12 and the adhesive tape 14 in one direction.

Furthermore, it is repeated that an area which partially overlaps the area pressed previously by one of the pressure heads 22 is pressed by another pressure head. Thereby, even if the adhesive surface is long in one direction, it is possible to reduce residual air bubbles and perform the attaching operation in an extremely short time.

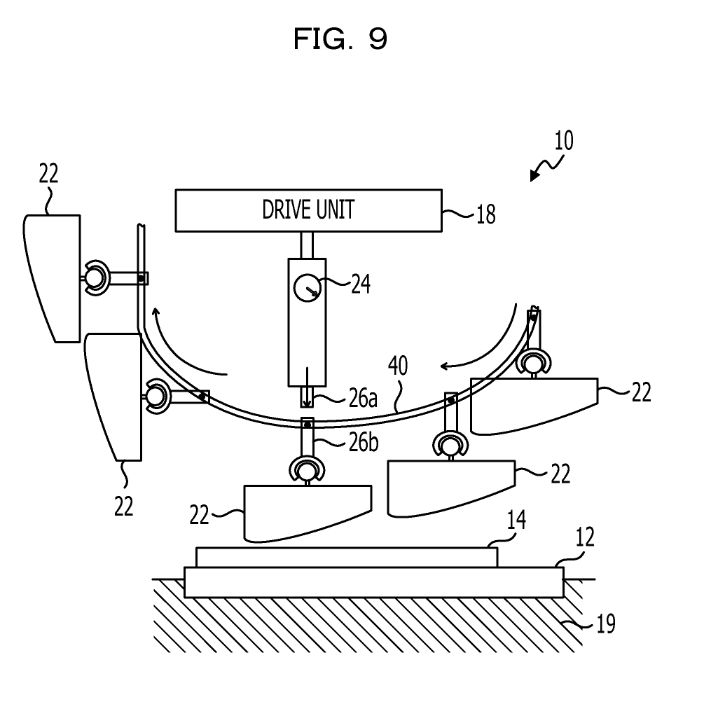

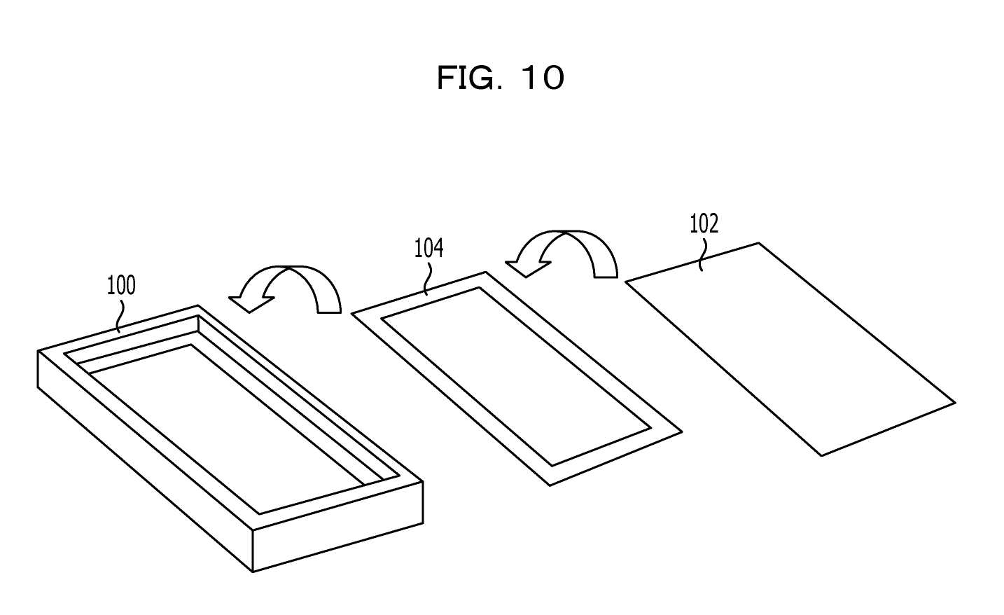

Such an operation of the pressure heads 22 may be performed by a pressure head movement mechanism 24. For example, as illustrated in FIG. 9, the pressure head movement mechanism 24 may realize the operation of the pressure heads 22 by a dynamic mechanism using a pressure head rail 40 provided with a plurality of pressure heads 22.

On the pressure head rail 40, a plurality of pressure heads 22 move in a direction of arrows at a constant speed by a drive motor not illustrated in FIG. 9. An upper pressure rod 26a and a drive section of the upper pressure rod 26a may move in a left-right direction in the example of FIG. 9 at a constant speed. When one of the pressure heads 22 comes to a position of the upper pressure rod 26a that is connected to the drive unit 18, the upper pressure rod 26a moves down and presses the lower pressure rod 26b. Thereby, the pressure head 22 presses the adhesive tape 14 to the housing 12.

In this way, in the fourth modified example, it is possible to press the adhesive tape 14 at a predetermined pressure position with the plurality of pressure heads 22 on the pressure head rail 40 provided with the plurality of pressure heads 22.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A display bonding device comprising:
a stage configured to place an adhesive tape and an adherend thereon;
a pressure head configured to press the adhesive tape onto the adherend with a pressure surface having a tapered shape or a curved shape which is tilted with respect to the stage; and
a movement mechanism configured to move the pressure head toward the adhesive tape through a pressure rod which is coupled to the pressure head,
wherein the pressure head is configured to rotate around the pressure rod.

2. The display bonding device according to claim 1, wherein the pressure rod comprises a convex portion protruding toward the pressure head, and
the pressure head comprises a concave portion swingably connected to the convex portion of the pressure rod.

3. The display bonding device according to claim 1, wherein the pressure rod comprises a concave portion protruding toward the pressure head, and
the pressure head comprises a convex portion swingably connected to the concave portion of the pressure rod.

4. The display bonding device according to claim 2, wherein
the convex portion of the pressure rod has a conical shape or a circular truncated conical shape, and
the concave portion of the pressure head has an opening angle larger than the convex portion of the pressure rod.

5. The display bonding device according to claim 3, wherein
the convex portion of the pressure head has a conical shape or a circular truncated conical shape, and
the concave portion of the pressure rod has an opening angle larger than the convex portion of the pressure head.

6. The display bonding device according to claim 1, wherein the pressure head comprises a balancer configured to move on the pressure head such that a tilt angle of the pressure surface of the pressure head is adjusted with respect to the stage.

7. The display bonding device according to claim 1, wherein a resin sheet is provided on the pressure surface of the pressure head.

8. A display bonding device comprising:
a stage configured to place an adhesive tape and an adherend thereon;
a plurality of pressure heads configured to press the adhesive tape onto the adherend with a pressure surface having a tapered shape or a curved shape which is tilted with respect to the stage; and
a movement mechanism configured to move the pressure head toward the adhesive tape through pressure rods coupled to the corresponding pressure heads,
wherein the pressure heads are configured to rotate around the corresponding pressure rods, and
the plurality of pressure heads are arranged in a row such that a pressure position at which the adhesive tape and the adherend are pressed sequentially moves.

9. The display bonding device according to claim 8, wherein the plurality of pressure heads are arranged such that the pressure position of the pressure heads partially overlap each other.

10. The display bonding device according to claim 8, wherein a moving direction of the pressure position of the pressure heads is a direction in which the pressure surface of a tapered shape or curved shape is tilted with respect to the stage.

11. A display bonding method comprising:
pressing a first area of an adhesive tape with a first pressure head among a plurality of pressure heads configured to press the adhesive tape onto an adherend with a pressure surface having a tapered shape or a curved shape; and
pressing a second area of the adhesive tape partially overlapping the first area with a second pressure head among the plurality of pressure heads.
